(19) United States
(12) Patent Application Publication
(10) Pub. No.: US 2024/0423164 A1
(43) Pub. Date: Dec. 26, 2024

(54) Laboratory Rodent Nesting and Exercise Devices

(71) Applicant: Chelsea Christina Menke, Gambier, OH (US)

(72) Inventor: Chelsea Christina Menke, Gambier, OH (US)

(21) Appl. No.: 18/653,003

(22) Filed: May 2, 2024

Related U.S. Application Data
(60) Provisional application No. 63/510,049, filed on Jun. 23, 2023.

(51) Int. Cl. A01K 15/02; A01K 1/03

(52) U.S. Cl. CPC A01K 15/027; A01K 1/031

(57) ABSTRACT

Systems in accordance with embodiments of the invention are disclosed. In one embodiment, a rodent enrichment device is provided, the rodent enrichment device comprising: an at least one exercise compartment for a rodent to engage in exercise; the exercise compartment comprising a first access point, and a running wheel, wherein the running wheel is connected to the exercise compartment and the first access point allows the rodent to enter and exit the exercise compartment; and an at least one nesting compartment, connected to the exercise compartment, for the rodent to perform nesting behaviors, the nesting compartment comprising a loft floor and a second access point, wherein the loft floor is elevated from a base floor of a rodent cage.

### CROSS-REFERENCE TO RELATED APPLICATIONS

The current application claims priority to U.S. Provisional Patent Application No. 63/510,049 filed on Jun. 23, 2023, the disclosures of which are incorporated herein by reference.

### FIELD OF THE INVENTION

The present invention generally relates to animal housing devices and more specifically, to laboratory rodent exercise and nesting devices.

### BACKGROUND

Rodents have long been used in biomedical research as animal models. Common usages of rodents for research include determination of the efficacy of new drugs and their effects on animal models. Laboratory rodents are optimal animal models due to their relatively short gestation periods and large litters that allow for genetic selection according to experimental needs and purposes. Laboratory rodents are commonly mice and rats.

At any time, a laboratory may house many rodent colonies for various research purposes. With many colonies of different strains, laboratory rodents must be housed in an economical and cost-effective manner. Specially designed rodent cage racks house many rodent cages that are designed for compatibility with such racks. With specific requirements for food and water, these rodent cages are often space-constrained.

Though laboratory rodents are genetically distinct from their wild counterparts, environments that allow rodents to exercise natural behaviors benefit both rodent and researcher. Rodents in such environments exhibit improved health outcomes, leading to reliable and replicable experimental results.

### SUMMARY OF THE INVENTION

The various embodiments of the present laboratory rodent exercise and nesting devices (also referred to as “rodent enrichment devices”) contain several features, no single one of which is solely responsible for their desirable attributes. Without limiting the scope of the present embodiments, their more prominent features will now be discussed below. In particular, the present rodent enrichment device will be discussed in the context of the laboratory environment. However, the use of rodent enrichment devices for laboratory rodents is merely exemplary and various other enrichment devices may be utilized for rodent exercise and nesting as appropriate to the requirements of a specific application in accordance with various embodiments of the invention. After considering this discussion, and particularly after reading the section entitled “Detailed Description,” one will understand how the features of the present embodiments provide the advantages described here.

In a first aspect, a rodent enrichment device is provided, the rodent enrichment device comprising an at least one exercise compartment for a rodent to engage in exercise; the exercise compartment comprising a first access point, and a running wheel, the running wheel is connected to the exercise compartment and the first access point, allowing the rodent to enter and exit the exercise compartment; and an at least one nesting compartment, connected to the exercise compartment, for the rodent to perform nesting behaviors, the nesting compartment comprising a loft floor and a second access point, where the loft floor is elevated from a floor of a rodent cage.

In an embodiment of the first aspect, the loft floor of the at least one nesting compartment comprises evenly spaced holes.

In another embodiment of the first aspect, the evenly spaced holes are no larger than the rodent's foot to prevent rodent appendages from being caught in the loft floor.

In another embodiment of the first aspect, the rodent enrichment device further comprises a bottom floor, a first side wall, a second side wall, and a ceiling of the rodent enrichment device.

In another embodiment of the first aspect, the rodent enrichment device forms a cuboid shape with two open faces.

In another embodiment of the first aspect, the bottom floor of the rodent enrichment device is wider than the ceiling of the rodent enrichment device to provide stability.

In another embodiment of the first aspect, a leg supports the at least one nesting compartment to allow additional rodents to use the nesting compartment.

In another embodiment of the first aspect, the rodent enrichment device comprises protrusions from the rodent enrichment device to allow suspension of the rodent enrichment device from between an edge of the cage and a cage lid.

In another embodiment of the first aspect, the at least one nesting compartment comprises a second access point that allows the rodent to enter and exit the at least one nesting compartment.

In another embodiment of the first aspect, area of a base of the rodent enrichment device is between 10% and 50% of an area of the rodent cage floor.

In another embodiment of the first aspect, volume of the rodent enrichment device is between 10% and 50% of an interior volume of the rodent cage.

In another embodiment of the first aspect, the at least one exercise compartment and the at least one nesting compartment are made of an autoclavable and cage-wash temperature-tolerant material.

In another embodiment of the first aspect, the material comprising the at least one exercise compartment and the at least one nesting compartment is red and translucent.

In another embodiment of the first aspect, the material is made of polypropylene and polypropylene copolymer, fluoropolymer, or polycarbonate.

In another embodiment of the first aspect, the running wheel is detachable from the rodent enrichment device.

In another embodiment of the first aspect, the nesting compartment further comprises the loft floor, a first side wall, a second side wall, and a ceiling of the rodent enrichment device.

In another embodiment of the first aspect, the nesting compartment further comprises a cuboid shape with at least one open face.

### BRIEF DESCRIPTION OF THE DRAWINGS

The various embodiments of the present laboratory rodent exercise and nesting devices (may also be referred to as “rodent enrichment device”) will now be discussed in detail with an emphasis on highlighting the advantageous features. These embodiments depict the novel and non-obvious rodent enrichment devices shown in the accompanying drawings which are for illustrative purposes only. These drawings include the following figures:

FIG. 1 is a diagram illustrating a rodent enrichment device within a laboratory rodent cage (also referred to as a “rodent cage” or “cage”) in accordance with an embodiment of the invention.

FIG. 2A illustrates a perspective view of a rodent enrichment device in accordance with an embodiment of the invention.

FIG. 2B illustrates a top view of a rodent enrichment device in accordance with an embodiment of the invention.

FIG. 3A illustrates a front side perspective view of an exercise wheel of a rodent enrichment device in accordance with an embodiment of the invention.

FIG. 3B illustrates a back side perspective view of an exercise wheel of a rodent enrichment device in accordance with an embodiment of the invention.

FIG. 4 illustrates a perspective view of a hanging rodent enrichment device in accordance with an embodiment of the invention.

FIG. 5 illustrates a perspective view of a stackable rodent enrichment device in accordance with an embodiment of the invention.

FIG. 6 illustrates a perspective view of a rodent enrichment device with multiple exercise and nesting compartments in accordance with an embodiment of the invention.

### DETAILED DESCRIPTION OF THE DRAWINGS

The following detailed description describes the present embodiments with reference to the drawings. In the drawings, reference numbers label elements of the present embodiments. These reference numbers are reproduced below in connection with the discussion of the corresponding drawing features.

Turning now to the drawings, laboratory rodent exercise and nesting devices in accordance with embodiments of the invention are illustrated. Rodent enrichment devices may be placed within rodent cages to allow for additional floor space and for rodents to engage in exercise. In several embodiments, a rodent enrichment device may include various compartments such as, but not limited to one or more nesting compartments and one or more exercise compartments. In many embodiments, the nesting compartment may be elevated from the floor of the rodent cage. In various embodiments, the loft floor of the nesting compartment may have holes to allow for fluids to drain to the floor of the rodent cage while small enough to ensure that rodent appendages are not caught in the loft floor. In some embodiments, the holes of the nesting compartment may be evenly and incrementally spaced on the floor of the nesting compartment.

In several embodiments, the rodent enrichment device may be shaped for optimal usage in a laboratory setting. For example, the rodent enrichment device may be a cuboid with two open faces to allow stacking of multiple rodent enrichment devices for ease of storage. In several embodiments, the nesting compartment may also include level ceilings to allow for easy stacking of multiple rodent enrichment devices in laboratory settings. In many embodiments, the nesting compartment may include vertical walls having one or more access points to allow a rodent to enter and exit the nesting compartment. In some embodiments, support legs may be utilized below the nesting compartments to allow multiple rodents to use the nesting compartment and to ensure structural integrity of the rodent enrichment device. In various embodiments, the nesting compartment may be configured for monitoring of rodents in the laboratory setting. For example, the nesting compartment may be translucent to allow researchers to monitor rodents in the nesting compartment. In some embodiments, the nesting compartment may be translucent and tinted red so that rodents within the nesting compartment remain undisturbed while being monitored due to rodents' inability to perceive the color red. Such a configuration may encourage natural nesting behaviors.

In many embodiments, rodent enrichment devices may also include one or more exercise compartments. In various embodiments, the exercise compartment may include a running wheel. In several embodiments, the running wheel may be attached to a wall of the nesting compartments. In various embodiments, the running wheel may include grooves or ridges to give the rodents greater traction when they use the running wheel. Use of the wheel allow rodents to complete habitual exercises common to rodents in their natural habitats. In some embodiments, the running wheel may be attached via a removable pin. In some embodiments, the running wheel may be attached by a horizontal rod that runs between the center of the wheel and the nesting compartment wall. In some embodiments, the running wheel may be attached by another attachment mechanism. In other embodiments, the running wheel may be attached to the outside of the rodent enrichment device. In some embodiments, the running wheel may be attached to the inside wall of the exercise compartment.

In various embodiments, the rodent enrichment device may include protrusions that extend from an upper edge of the nesting compartment to suspend the rodent enrichment device from the floor of the cage. In some embodiments, the protrusions may be various sizes, shapes, and styles to accommodate the different models of rodent cages available for laboratory use. In many embodiments, the running wheel may also be attached to a suspended rodent enrichment device. Rodent enrichment devices in accordance with embodiments of the invention are further discussed below.

### Rodent Enrichment Devices

In typical laboratory settings, rodents are housed in rodent cages without the ability to complete natural behaviors due to various limitations such as the size and space constraints of the rodent cages. The inability to complete natural behaviors can impair rodent health. Natural behaviors include traveling across territories and creating nests as a “home base.” Rodents may travel multiple miles a day. Rodent enrichment devices allow rodents to exhibit similar behaviors within the constraints of the cages. For example, rodent enrichment devices provide rodents with additional floor space; the ability to perform nesting behaviors within one or more nesting compartments; and the opportunity to mimic travel utilizing one or more exercise compartments. Additional spaces to encourage nesting behaviors are beneficial in such constrained spaces. In tightly confined spaces, rodents may display aggressive and territorial tendencies that can be detrimental to the health outcomes of the rodents, especially the weaker rodents. These additional spaces provide opportunity for weaker rodents to hide. Improving health outcomes of laboratory rodent populations benefit researchers by producing more reliable scientific results and by reducing the number of rodents needed for research experiments.

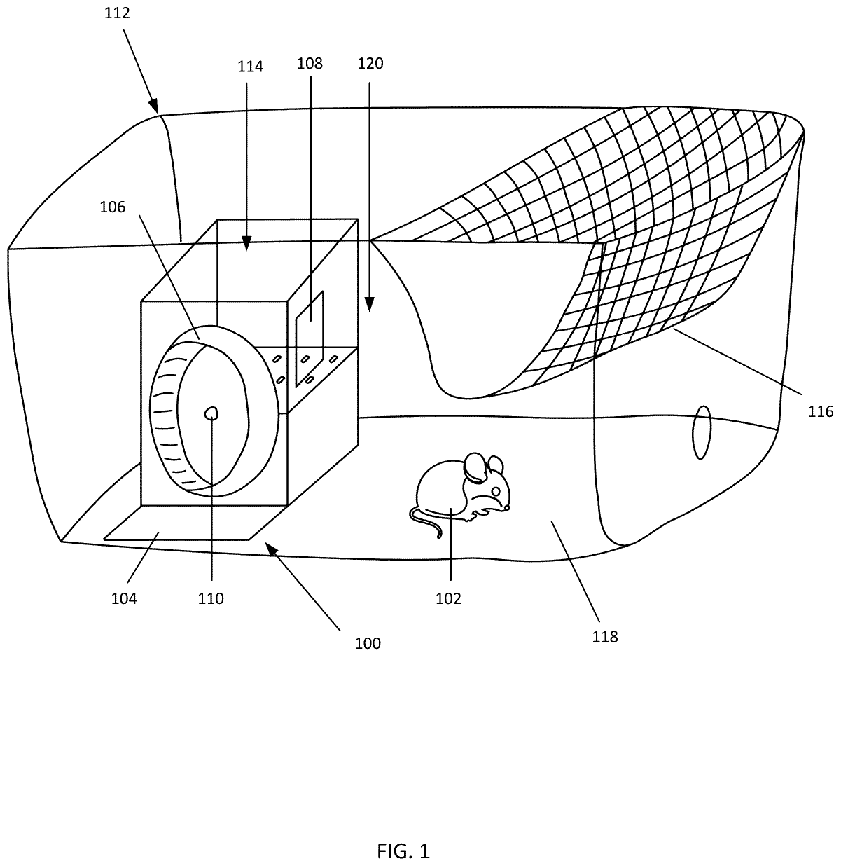

A diagram illustrating a rodent enrichment device within a rodent cage in accordance with an embodiment of the invention is shown in FIG. 1. FIG. 1 depicts a rodent enrichment device 100 situated in a rodent cage 112. In many embodiments, the rodent enrichment device 100 may be placed in an empty space 120 of the rodent cage 112. For example, in a conventional laboratory set-up, the rodent cages would have an empty space 120. Although such an empty space gives the rodent some space to move, it may be small and inadequate for rodents to perform behaviors consistent with rodents in their natural habitats. Further, when multiple rodents share a single cage as is common in research laboratories, the empty space may be especially inadequate for providing a safe environment when rodents exhibit territorial behaviors such as fighting and biting. Depending on the size of the empty space, rodent enrichment devices may be various sizes and configurations, as further described below. As illustrated in FIG. 1, the rodent enrichment device 100 may be placed in a corner of the rodent cage 112.

In reference to FIG. 1, the rodent enrichment device 100 may include a nesting compartment 114 and an exercise compartment 104. In various embodiments, the nesting compartment 114 and the exercise compartment 104 may be stacked horizontally to maximize the use of the limited space within the cage 112. The nesting compartment 114 may have at least one access point 108, which may allow a rodent 102 to enter the nesting compartment 114 and perform natural nesting behaviors. For example, as in a natural habitat, laboratory rodents have habits of creating a nest that is separated from other components of the cage including the cage's food station 116. In several embodiments, the nesting compartment 114 may be elevated from the floor 118 of the rodent cage 112, as further discussed below.

In further reference to FIG. 1, the exercise compartment 104 may include various exercise equipment such as, but not limited to, a running wheel 106. The rodent 102 may use a running wheel 106 to exercise as in the wild. In the wild, rodents are very active, traveling up to multiple miles per day. In many embodiments, the exercise compartment 104 may be open space with a running wheel 106 placed in the center of the exercise compartment 104. In some embodiments, the running wheel 106 may be attached to the nesting compartment 114 by attachment mechanism 110 that allows the running wheel 106 to rotate within the exercise compartment 104. In some embodiments, the running wheel 106 may be attached by attachment mechanism 110 such as, but not limited to, a pin, rod, wire, button, or any other fastener. In various embodiments, the rodent enrichment device 100 may be made of autoclavable and cage-wash temperature-tolerant material to allow researchers to easily sanitize the rodent enrichment device 100 for reuse in the same rodent cage or a different cage. The rodent enrichment device 100 may be made from borosilicate glass; stainless steel; polycarbonate plastics; polypropylene combined with polypropylene copolymer; a combination of fluoropolymer, polytetrafluoroethylene, and teflon; polyetheretherketone; polyamide imide; polyetherimides; or other similar autoclavable and cage-wash temperature-tolerant materials.

Although specific rodent enrichment devices having exercise and nesting compartments are discussed above with respect to FIG. 1, any of a variety of rodent enrichment devices can be utilized in accordance with embodiments of the invention, including a variety of nesting compartments and exercise compartments for various rodent cages as appropriate to the requirements of a specific application. A first preferred embodiment of the rodent enrichment device in accordance with embodiments of the invention are discussed further below.

### Rodent Enrichment Device for Conservation of Cage Space

In typical laboratory settings, rodents are placed in cages that have specific constraints by the standards and regulations set by various guidelines such as, but not limited to, the Guide for Care and Use of Laboratory Animals. Because labs may be financially constrained by limited funds, researchers may seek to maximize the number of their experiments while limiting expenditures on resources such as additional cages. This incentivizes researchers to place as many rodents in rodent cages as allowable. This leaves rodents with limited space to exhibit natural behaviors such as nesting and running. Opportunity for rodents to exhibit both natural behaviors is important to maintaining rodent health. Additionally, in the limited confines of laboratory rodent enclosures, rodents in the same enclosure can exhibit territorial behavior such as fighting and biting. The confined space reduces the ability of weaker rodents to avoid the more aggressive rodents.

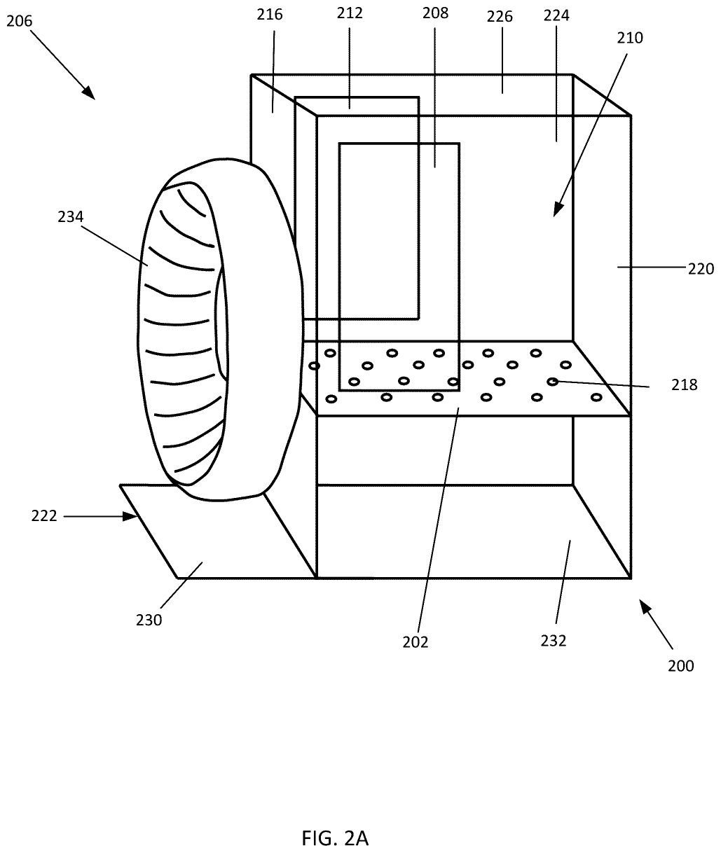

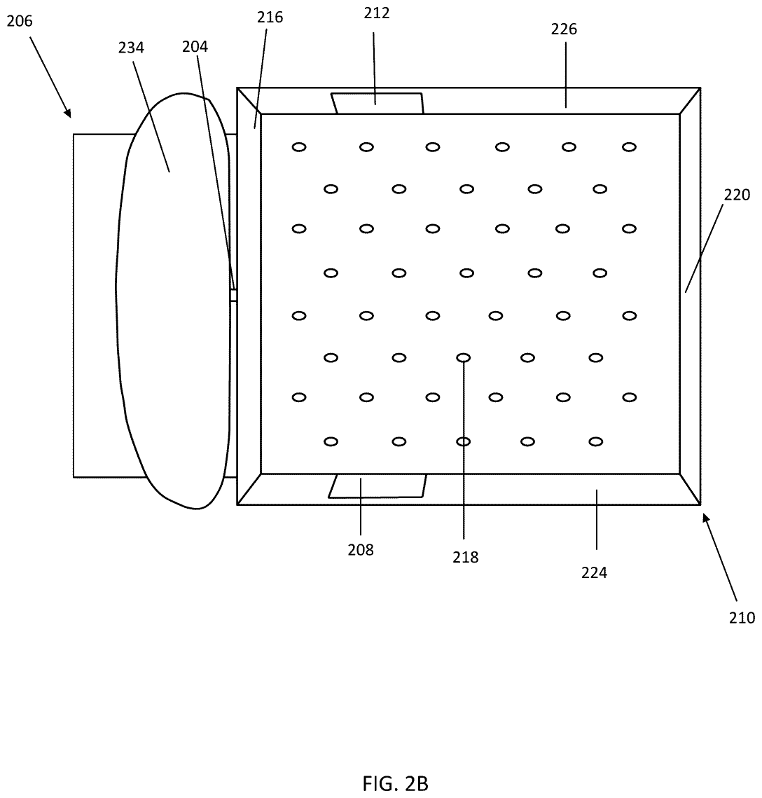

A diagram illustrating a perspective view of a rodent enrichment device in accordance with the invention is shown in FIG. 2A. In many embodiments, a rodent enrichment device 200 may include a nesting compartment 210 and an exercise compartment 206. The rodent enrichment device 200 may be made of various materials such as, but not limited to, an autoclavable and/or cage-wash temperature-tolerant material to allow for easy sanitization of the rodent enrichment device 200 to ensure the sterility of the rodents' environment in the continual reuse of the rodent enrichment device 200. For example, the rodent enrichment device 200 may be made using borosilicate glass; stainless steel, polycarbonate plastics; polypropylene combined with polypropylene copolymer; a combination of fluoropolymer, polytetrafluoroethylene, and teflon; polyetheretherketone; polyamide imide; polyetherimides; or other similar autoclavable materials.

In reference to FIG. 2A, the nesting compartment 210 may be partially enclosed by a loft floor 202, a first wall 216, a second wall 220, a third wall 224, and a fourth wall 226. In various embodiments, the fourth wall 226 may be positioned opposite the third wall 224. In some embodiments, there may be an empty space between the third wall 224 and fourth wall 226 that functions as an opening to allow for rodents to enter and exit the one or more nesting compartments 210 via a first access point 208 or a second access point 212. The first access point 208 and the second access point 212 may allow the rodents to enter and exit the nesting compartment 210 and return to a base floor 222 of the rodent enrichment device 200 or the cage that the rodent enrichment device 200 is placed within.

In further reference to FIG. 2A, the nesting compartment 210 may include a loft floor 202 elevated off the first portion 232 of the base floor 222 of the rodent enrichment device 200. In several embodiments, the loft floor 202 may be elevated to allow for additional floor space for rodents in the laboratory cages as discussed above. The base floor 230 of the rodent enrichment device 200 may provide stability for the device while in use as it may support the entirety of the rodent enrichment device 200. The loft floor 202 of the nesting compartment 210 may have openings such as, but not limited to, holes 218. In some embodiments, the holes 218 may be evenly and incrementally spaced. For example, in some embodiments, the holes 218 may be no larger than a rodent's foot to prevent rodent appendages from becoming stuck within loft floor 202. Further, holes 218 may ensure that any fluid within the nesting compartment 210 drains to the base floor 222 of the rodent enrichment device 200 to improve comfort and sanitation of rodents using the nesting compartment 210.

In further reference to FIG. 2A, the nesting compartment 210 may include a first wall 216, a second wall 220, a third wall 224, and a fourth wall 226. In some embodiments, the first, second, third, and fourth walls 216, 220, 224, 226 may be made of a translucent and shaded material. For example, the first, second, third, and fourth walls 216, 220, 224, 226 may be made using a translucent red material. The translucent red material may ensure that the rodents remain undisturbed during resting hours in the laboratory while simultaneously allowing researchers to monitor the rodents. Specifically, rodents are unable to see the color red so while the material itself is see-through to researchers, the rodents are unable to see through the compartments allowing them to remain undisturbed even when being monitored.

In further reference to FIG. 2A, the exercise compartment 206 may include a running wheel 234 elevated off a second portion 230 of the base floor 222. In various embodiments, the running wheel 234 ensures that rodents are able to exercise mimicking rodents in natural habitats that travel distances to forage for food.

A diagram illustrating a top view of a rodent enrichment device in accordance with the invention is shown in FIG. 2B. As described above, the rodent enrichment device 200 may include the exercise compartment 206, having a running wheel 234, and the nesting compartment 210. In some embodiments, the nesting compartment 210 may include the first, second, third, and fourth walls, 216, 220, 224, 226, and first and second access points 208, 212. In addition, the nesting compartment 210 may include holes 218, as further described above. In various embodiments, the running wheel 234 may be connected to the nesting compartment 210 via an attachment mechanism 204. For example, the attachment mechanism 204 may include pin, rod, wire, button, or any other fastener that allows rotation of the running wheel 234. In several embodiments, the attachment mechanism may allow for the rotation of the running wheel such that rodents, despite the limited space of the cage, may use the running wheel to run and exhibit natural behaviors involved in their daily foraging for food.

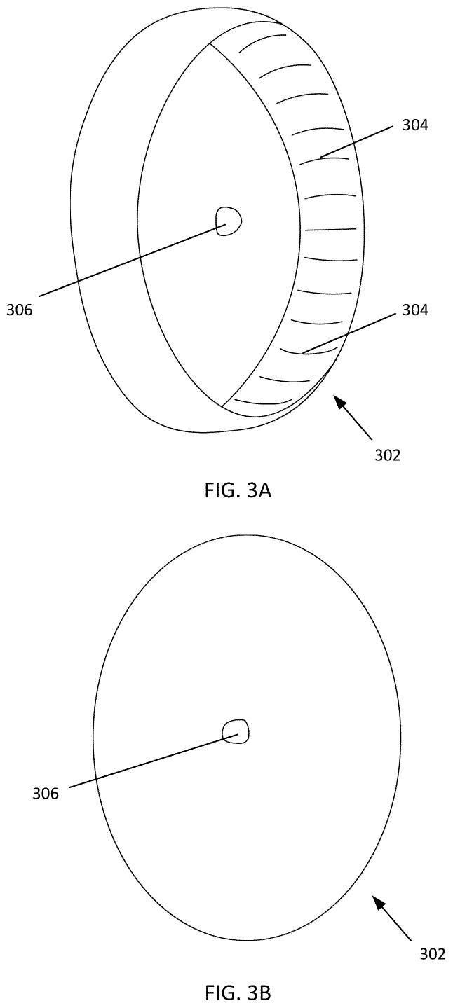

A diagram illustrating a front side perspective view of a running wheel of a rodent enrichment device in accordance with the invention is shown in FIG. 3A. The running wheel 302 may attach via an attachment mechanism 306, as further described above. In several embodiments, the running wheel 302 may include traction. For example, the running wheel 302 may include three-dimensional traction strips 304. In some embodiments, the three-dimensional traction strips 304 may be grooves and/or ridges. The traction strips 304 may allow rodents to gain traction on the running wheel 302 and ensure proper use during exercise.

A back side perspective view of an exercise wheel of a rodent enrichment device in accordance with an embodiment of the invention is shown in FIG. 3B. As described above, the running wheel 302 may include an attachment mechanism 306, as further described above. In some embodiments, the attachment mechanism 306 may be an opening fitted to receive a corresponding attachment mechanism such as, but not limited to, a pin, rod, wire, button, or any other fastener.

Although specific embodiments of rodent enrichment devices for space-constrained cages are discussed above with respect to FIGS. 2A-3, any of a variety of rodent enrichment devices including a variety of nesting compartments, exercise compartments, running wheels, three-dimensional traction strips, and attachment mechanisms as appropriate to the requirements of a specific application can be utilized in accordance with embodiments of the rodent enrichment device. Hanging configurations of rodent enrichment devices (may also be referred to as a “hanging rodent enrichment devices”) in accordance with embodiments of the invention are discussed further below.

### Hanging Configuration of Rodent Enrichment Device

In typical laboratory settings, the rodent cage may be substantially limited in space. For example, the cage may be occupied by various enrichments including, but not limited to, additional food pellets, mouse huts, etc. In such cages, rodent enrichment devices may be configured to fit in such substantially limited space by occupying empty vertical space. Such rodent enrichment devices may utilize the vertical space by suspension from the edge of the rodent cage. Rodents may access such a device by jumping or climbing. Rodents in such space-constrained cages may especially benefit from the use of hanging rodent enrichment devices having one or more nesting compartments and exercise equipment (e.g., a running wheel), as further described above.

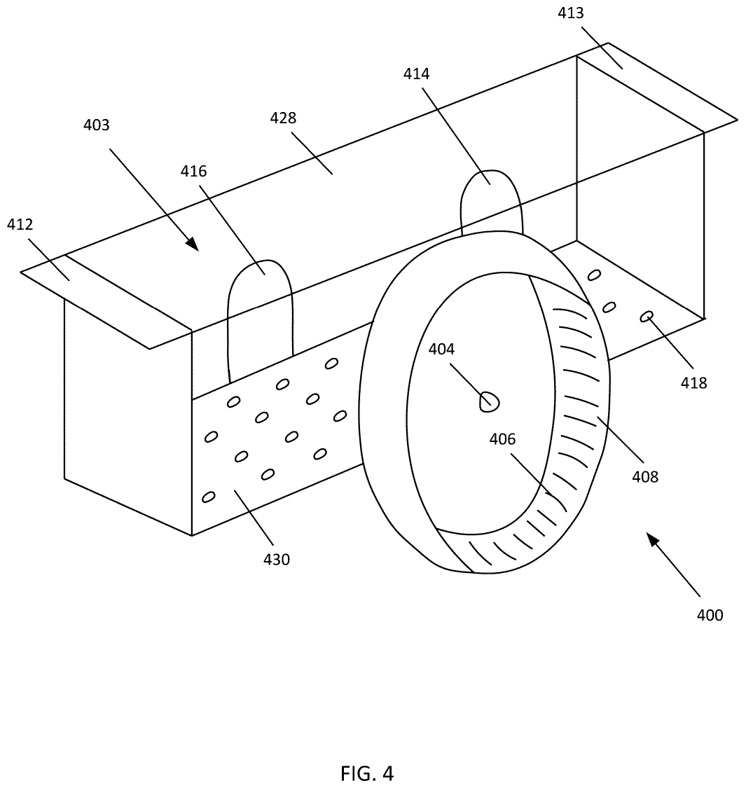

A perspective view of a hanging rodent enrichment device in accordance with an embodiment of the invention is shown in FIG. 4. A hanging rodent enrichment device 400 may include a nesting compartment 403 and a running wheel 408. In many embodiments, the running wheel 408 may be attached to a wall of the nesting compartment 403 using various attachment mechanisms 404. For example, the attachment mechanism 404 may be a pin, rod, wire, button, or any other fastener that allows rotation of the running wheel 408. In some embodiments, the running wheel 408 may include three-dimensional traction strips 406. The strips 406 may be grooves or ridges that allow the rodent to gain traction while using the running wheel 408. In some embodiments, the wall 428 opposite the running wheel 408 may include a first access point 414 and a second access point 416 to allow rodents to enter and exist nesting compartment 403.

In further reference to FIG. 4, the hanging rodent enrichment device 400 may include a loft floor 430 that may include one or more holes 418 to allow fluids to drain from nesting compartment 403. In some embodiments, the holes 418 may be no larger than a rodent's foot to prevent rodent appendages from becoming stuck within loft floor 430. In some embodiments, the holes 418 may be evenly spaced throughout loft floor 430. In many embodiments, the nesting compartment 403 may also include protrusions 412 and 413 that allow the hanging rodent enrichment device 400 to be suspended from the floor of the cage. The protrusions 412 and 413 include, but are not limited to, latches, ledges, hooks, flaps, or any other mechanism that allows the hanging rodent enrichment device 400 to be suspended within the cage.

Although specific embodiments of hanging rodent enrichment devices for space-constrained cages are discussed above with respect to FIG. 4, any of a variety of configurations including, but not limited to, hanging configurations of rodent enrichment devices as appropriate to the requirements of a specific application can be utilized in accordance with embodiments of the invention. Stackable configurations of rodent enrichment devices (may also be referred to as “stackable rodent enrichment devices”) in accordance with embodiments of the invention is discussed further below.

### Stackable Configurations of Rodent Enrichment Devices

In typical laboratory settings, laboratory space is limited, so stackable devices can save valuable storage space. In typical laboratory settings, the rodent cages may undergo a continuous cleaning cycle. The cleaning cycle includes removing bedding, food, animal waste, and any other objects in the cage; washing the cage with sterilization techniques; and placing fresh bedding within the cage. The extensive washing cycle is necessary to remove all scent of previous rodent inhabitants and to prevent the growth of disease-causing bacteria and virus. Any remaining scent from previous rodent inhabitants may cause anxiety and discomfort for new rodent inhabitants. The presence of disease-carrying bacteria and virus may cause sickness in rodents that diminish the accuracy of scientific experiments and results. For these reasons, all contents of the rodent cage must be cleaned and sterilized for reuse, including the rodent enrichment devices. To maximize the number of rodent enrichment devices that can be sterilized in one sterilization cycle, rodent enrichment devices may benefit from a shape that allows for stackability. Additionally, extra stock of the rodent enrichment devices may be kept to accommodate the large number of rodent cages required for laboratory use. Because space in laboratories is limited, efficient storage of the rodent enrichment device is required, again demonstrating a need for enrichment devices that allow for stackability.

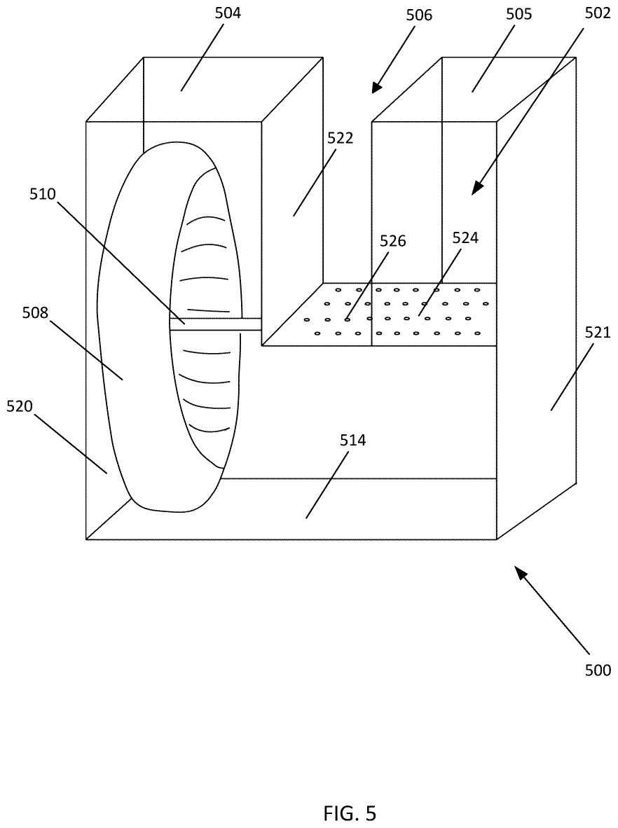

A perspective view of a stackable rodent enrichment device in accordance with an embodiment of the invention is shown in FIG. 5. A stackable rodent enrichment device 500 may include a nesting compartment 502 and a running wheel 508. In some embodiments, the running wheel 508 may be attached to a first wall 520 by an attachment mechanism 510 that may be a pin, rod, wire, button, or any other fastener, as further described above. For example, the attachment mechanism 510 may be a rod that is fastened to both the first wall 520 and an inner wall 522. In many embodiments, the first wall 520 and the inner wall 522 may extend at a 90 degree angle from a base floor 514. In some embodiments, the first wall 520 may make contact with a first ceiling 504 at a 90 degree angle. In some embodiments, the inner wall 522 may make contact with a second ceiling 505 at a 90 degree angle. In many embodiments, the first ceiling 504 and the second ceiling 505 may be parallel with a base floor 514. The base floor 514, first wall 520, second wall 521, first ceiling 504, and second ceiling 505 may form a cuboid shape with flat parallel surfaces that allow for efficient stacking. In various embodiments, the nesting compartment 502 may be bounded by loft floor 524, vertical wall 522, and ceiling 505. In several embodiments, the loft floor 524 may be elevated from the base floor 514 and include holes 526, as further described above. For example, in some embodiments, the holes 526 may be no larger than a rodent's foot to prevent rodent appendages from becoming stuck within loft floor 524. In some embodiments, the stackable rodent enrichment device 500 may include an access point 506 that is formed between the first ceiling 504 and the second ceiling 505 and bounded by the inner vertical wall 522. The access point 506 may allow rodents to access nesting compartment 502.

Although specific embodiments of rodent enrichment devices that allow stackability are discussed above with respect to FIG. 5, any of a variety of rodent enrichment devices including a variety of shapes and sizes that allows for stackability as appropriate to the requirements of a specific application can be utilized in accordance with embodiments of the invention. Multiple compartment configurations of rodent enrichment devices (may also be referred to as “multi-unit rodent enrichment device”) in accordance with embodiments of the invention is discussed further below.

### Multiple Compartment Configuration of Rodent Enrichment Device

In typical laboratory settings, numerous rodents occupy a single cage, leading to crowded cages. Crowded cages can lead to poor health outcomes for rodents. It may also lead to fighting among the rodents inhabiting the cage as the rodents compete for space within the cage. Additionally, with the limited floor space being occupied by rodents, there is reduced space for the rodents to move around like they would do while traveling in the wild. The inability to perform these two natural habits may lead to poor health outcomes, like sickness and possible death. Unhealthy rodents may cause inconsistent and irreplicable experimental results.

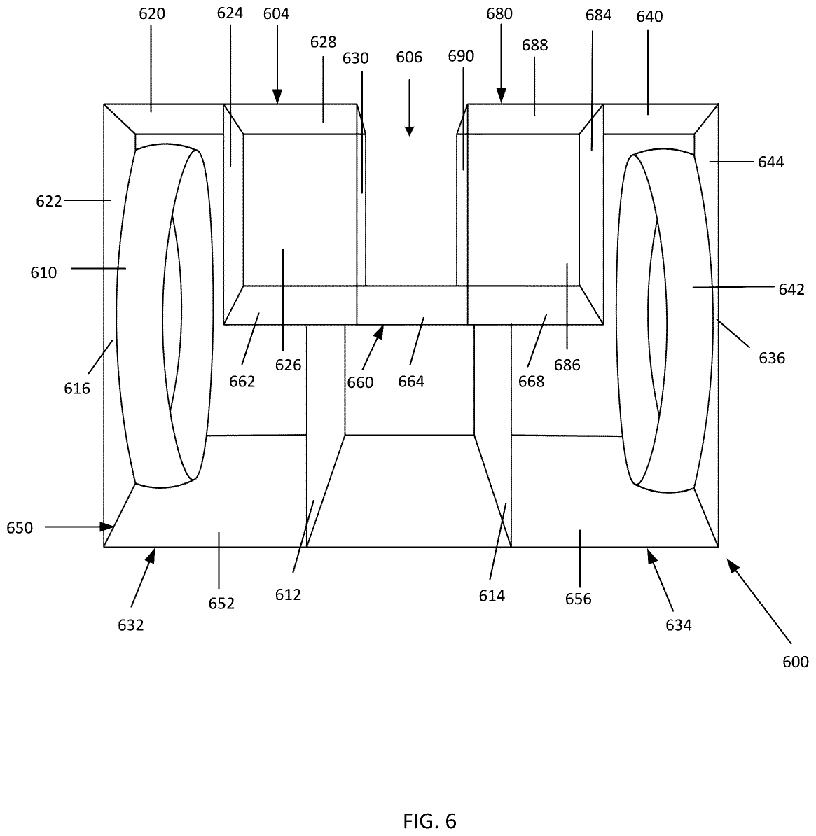

A perspective view of a rodent enrichment device with a plurality of exercise and a plurality of nesting compartments in accordance with an embodiment of the invention is shown in FIG. 6. A multi-unit rodent enrichment device 600 may include a first nesting compartment 604 and a second nesting compartment 680, and a first exercise compartment 632 and a second exercise compartment 634. In many embodiments, the multi-unit rodent enrichment device 600 may be made using autoclavable and cage-wash temperature-tolerant material, as further described above.

In reference to FIG. 6, the first exercise compartment 632 may include a first running wheel 610. In various embodiments, the first running wheel 610 may be attached to a first exterior wall 622 of the first exercise compartment 632 using various attachment mechanisms 616, as further described above. For example, the attachment mechanism 616 may be a pin, rod, wire, button, or any other fastener that allows rotation of the first running wheel 610 when the rodent runs on the first running wheel 610. In various embodiments, the first running wheel 610 may be enclosed by a first portion 652 of a base floor 650 and a ceiling 620 that allow for the device to maintain stability to ensure the rodents' safety while using the rodent enrichment device 600.

In further reference to FIG. 6, the second exercise compartment 634 may include a second running wheel 642. In various embodiments, the second running wheel 642 may be attached to a second exterior wall 644 of the second exercise compartment 634 using various attachment mechanisms 636, as described above. In various embodiments, the second running wheel 642 may be enclosed by a third section 656 of a base floor 650 and a ceiling 640 of the second exercise compartment 634 that allow for the device to maintain stability to ensure the rodents' safety while using the rodent enrichment device 600.

In further reference to FIG. 4, the first nesting compartment 604 may be partially enclosed by a first section 662 of a loft floor 660, a first wall 624, a ceiling 628, a second wall 626, and a third wall 630. In various embodiments, the third wall 630 may be positioned opposite the second wall 626. In many embodiments, there may be an empty space between the second wall 626 and third wall 630 that functions as an opening to allow for rodents to enter and exit the first nesting compartment 604 via an access point 606. The access point 606 may be a second portion 664 of the loft floor 660. The access point 606 may allow the rodents to enter and exit the nesting compartments and return to the base floor 650 of the rodent enrichment device or the cage. In several embodiments, the first nesting compartment 604 may be elevated from the base floor 650 of rodent enrichment device 600 via a first leg 612. The first leg 612 ensures that the first nesting compartment 604 remains elevated even if there are multiple rodents using the first nesting compartment 604 at one time. It may be important to ensure that the nesting compartment 604 remains elevated to help maximize the floor space available to the multiple rodents that are housed within the cage at one time.

In further reference to FIG. 4, the second nesting compartment 680 may be partially enclosed by a third portion 668 of the loft floor 660, a first wall 684, a ceiling 688, a second wall 686, and a third wall 690. In various embodiments, the third wall 690 may be positioned opposite the second wall 686. In multiple embodiments, there is an empty space between the second wall 686 and third wall 690 that functions as an opening to allow for rodents to enter and exit the second nesting compartment 680 via an access point 606. The access point 606 may be a second portion 664 of the loft floor 660. The access point 606 allows the rodents to enter and exit the nesting compartments and return to the floor 650 of the rodent enrichment device 600 or the cage. In several embodiments, the second nesting compartment 680 may be elevated from the floor 650 of rodent enrichment device 600 via a second leg 614. The second leg 614 ensure that the nesting compartments 680 remain elevated even if there are multiple rodents using the second nesting compartments 680 at one time. It is important to ensure that the second nesting compartment 680 remains elevated to help maximize the floor space available to the multiple rodents that are housed within the cage at one time.

Although specific embodiments of rodent enrichment devices having first and second exercise compartments and first and second nesting compartments are discussed above with respect to FIG. 6, any of a variety of multi-unit rodent enrichment devices including any number of exercise compartments and any number of nesting compartments as appropriate to the requirements of a specific application can be utilized in accordance with embodiments of the invention.

While the above description contains many specific embodiments of the invention, these should not be construed as limitations on the scope of the invention, but rather as an example of one embodiment thereof. It is therefore to be understood that the present invention may be practiced otherwise than specifically described, without departing from the scope and spirit of the present invention. Thus, embodiments of the present invention should be considered in all respects as illustrative and not restrictive.

What is claimed is:

1. A rodent enrichment device comprising:
an at least one exercise compartment for a rodent to engage in exercise; the exercise compartment comprising a first access point, and a running wheel, wherein:
the running wheel is connected to the exercise compartment; and
the first access point allows the rodent to enter and exit the exercise compartment;
an at least one nesting compartment, connected to the exercise compartment, for the rodent to perform nesting behaviors, the nesting compartment comprising a loft floor and a second access point, wherein the loft floor is elevated from a base floor of the rodent enrichment device.

2. The rodent enrichment device of claim 1, wherein the loft floor of the at least one nesting compartment comprises evenly spaced holes.

3. The rodent enrichment device of claim 2, wherein the evenly spaced holes are no larger than the rodent's foot to prevent rodent appendages from being caught in the loft floor.

4. The rodent enrichment device of claim 1 further comprising a base floor, a first side wall, a second side wall, and a ceiling of the rodent enrichment device.

5. The rodent enrichment device of claim 4, wherein the rodent enrichment device forms a cuboid shape with two open faces.

6. The rodent enrichment device of claim 4, wherein the base floor of the rodent enrichment device is wider than the ceiling of the rodent enrichment device to provide stability.

7. The rodent enrichment device of claim 1, wherein a leg supports the at least one nesting compartment to allow additional rodents to use the nesting compartment.

8. The rodent enrichment device of claim 1, wherein the rodent enrichment device comprises protrusions from the rodent enrichment device to allow suspension of the rodent enrichment device from between an edge of the cage and a cage lid.

9. The rodent enrichment device of claim 1, wherein the at least one nesting compartment comprises a second access point that allows the rodent to enter and exit the at least one nesting compartment.

10. The rodent enrichment device of claim 1, wherein an area of a base of the rodent enrichment device is between 10% and 50% of an area of the rodent cage floor.

11. The rodent enrichment device of claim 1, wherein a volume of the rodent enrichment device is between 10% and 50% of an interior volume of the rodent cage.

12. The rodent enrichment device of claim 1, wherein the at least one exercise compartment and the at least one nesting compartment are made of an autoclavable and cage-wash temperature-tolerant material.

13. The rodent enrichment device of claim 12, wherein the material comprising the at least one exercise compartment and the at least one nesting compartment is red and translucent.

14. The rodent enrichment device of claim 12, wherein the material is made of polypropylene and polypropylene copolymer, fluoropolymer, or polycarbonate.

15. The rodent enrichment device of claim 1, wherein the running wheel is detachable from the rodent enrichment device.

16. The rodent enrichment device of claim 1, wherein the nesting compartment further comprises the loft floor, a first side wall, a second side wall, and a ceiling of the rodent enrichment device.

17. The rodent enrichment device of claim 16, wherein the nesting compartment forms a cuboid shape with at least one open face.
